(19) United States
(12) Patent Application Publication
(10) Pub. No.: US 2009/0159375 A1
(43) Pub. Date: Jun. 25, 2009

(54) Control system for braking devices based on braking torque sensor

(75) Inventors: Andrea Lorenzo Vitali, Bergamo (IT); Nicola Cesario, Arzano (NA) (IT)

Correspondence Address: GRAYBEAL JACKSON LLP, 155 - 108TH AVENUE NE, SUITE 350, BELLEVUE, WA, 98004-5973, US

(73) Assignee: STMicroelectronics S.r.l., Agrate Brianza (IT)

(21) Appl. No.: 12/005,137

(22) Filed: Dec. 22, 2007

(30) Foreign Application Priority Data
Dec. 22, 2007 (IT) MI2006A002496

(51) Int. Cl. F16D 66/02; F16D 65/092

(52) U.S. Cl. 188/1.11 W; 188/250 R

(57) ABSTRACT

An embodiment of a control system of a braking device is provided. Said braking device includes at least one braking element adapted to apply a braking action to a moving body. The control system includes receiving means for receiving an indication of a target value of the braking action to be applied to the moving body, measuring means for measuring an indication of an actual value of the braking action applied to the moving body and driving means for driving the braking element according to a comparison between the target value and the actual value. The measuring means includes sensing means for sensing a warping of at least one part of the moving body and/or of the braking device, and logic means for estimating the actual value according to the warping.

### PRIORITY CLAIM

This application claims priority from Italian Patent Application No. MI2006A002496 filed Dec. 22, 2006, which is incorporated herein by reference.

### TECHNICAL FIELD

An embodiment of the present invention generally relates to the field of the brakes. In particular, to an embodiment of the control of braking devices.

### BACKGROUND

The braking devices—or more simply, brakes—are mechanical members, which are aimed at slowing down a moving member or keep it still. The so-called “standing brakes” are brakes, the specific aim of which is the maintenance of a given member at rest. The brakes aimed at slowing down and controlling the speed of a moving member are instead labelled by the term “exertion brakes”. An example of a standing brake is given by the hand brake of a vehicle, which has the function of keeping the wheels locked when the vehicle is parked. An example of an exertion brake is instead provided by the foot brake that acts on the same wheels when the vehicle is moving.

Making reference in particular to the exertion brakes for vehicles, a disk brake comprises a caliper associated with a braking disk integral to a wheel, and a driving hydraulic circuit. The caliper houses therein pads (generally in number equal to two) made up of friction material, and one or more pistons connected to the driving hydraulic circuit. Following an action exerted by a user of the vehicle on a proper pedal (the brake pedal), a pump in the driving hydraulic circuit applies pressure to a fluid contained in this circuit. Accordingly, the pistons come out from respective seats to press the corresponding pads against the braking disk surface, in such a way to exert a braking action on the wheel.

Recently, electronic control braking devices have been proposed, which provide the replacement of the hydraulic calipers with actuators of electro-mechanical type. In detail, proper sensors sense the actuation of the brake pedal, and generate corresponding electric signals, which are received and interpreted by a control system. The control system then regulates the intervention of the electro-mechanical actuators (for example, pistons driven by an electric motor) that exert the desired braking action on the braking disks through the corresponding pads. The control system further comprises a system of sensors associated with the braking device, which provides information about the braking action actually exerted by the electro-mechanical actuators. In this way it is possible to control the braking action by means of a closed-loop feedback. In particular, the control system receives, from the sensor system, information on the pressure exerted by each actuator on the respective braking disk. That information is used for deducing the actual trend of the braking action in progress. For this purpose, the action of the pistons of each braking device is monitored by pressure sensors, for example, based on a steel core with “strain gauge” elements or realized by means of integrated structures.

However, a solution of this type may not permit controlling the braking action in an optimal way, since what is monitored is only a physical quantity related to the braking action in an indirect way. Therefore, by means of such an indirect measure (i.e., the pressure exerted by each actuator on the respective braking disk) it may not be possible to obtain the actual braking action precisely (that is, the braking torque generated by the friction between the pads and the disk). In fact, the degree of such a braking action does not depend exclusively on the pressure that each piston exerts on the braking disk, but it also depends on other different factors. For example, the generated braking action greatly depends on the wear conditions of the pads and of the braking disks, on the presence of extraneous fluids, such as, for example, oil on the surface of the braking disks that is in contact with the pads, and on the temperature of the pads. Accordingly, at the same measured pressure between pistons and braking disk, the braking action exerted on the corresponding wheel—that is, the resulting braking torque exerted by the pads on the braking disk—can vary in an unpredictable way by significant amount, depending on all the factors cited above.

Accordingly, once the user of the vehicle has set the desired braking action by means of a proper working of the brake pedal, by using the known braking devices and control systems, it may be difficult to control the braking action that is actually occurring in an effective way.

### SUMMARY

In its general terms, one or more disclosed embodiments are based on the idea of measuring the actual braking action.

In particular, an embodiment of the present invention provides a control system of a braking device. The braking device includes at least one braking element for applying a braking action to a moving body. The control system includes receiving means for receiving an indication of a target value of the braking action to be applied to the moving body, measuring means for measuring an indication of an actual value of the braking action applied to the moving body and driving means for driving the braking element according to a comparison between the target value and the actual value. The measuring means includes sensing means for sensing a warping of at least one part of the moving body and/or of the braking device, and logic means for estimating the actual value according to the warping.

In an embodiment of the invention, the sensing means senses the warping of the braking device.

According to an embodiment of the invention the braking action is a braking torque opposing the rotation of a wheel.

In an embodiment of the invention the braking device is of disk type.

The sensing may sense the warping of a caliper system of the disk braking device.

In an embodiment of the invention the sensing means comprises a piezoresistive element.

Another embodiment of the invention is a braking apparatus including at least one corresponding braking device.

A further embodiment of the invention relates to a vehicle that includes such a braking apparatus.

Another embodiment of the invention provides a corresponding method for controlling a braking device.

A further embodiment of the invention provides a program for performing this method.

### BRIEF DESCRIPTION OF THE DRAWINGS

Features and advantages of one or more embodiments of the invention, will be best understood with reference to the following detailed description, given purely by way of a non-restrictive indication, to be read in conjunction with the accompanying drawings. In this respect, it is expressly intended that the figures are not necessary drawn to scale and that, unless otherwise indicated, they are merely intended to conceptually illustrate the structures and procedures described herein.

FIG. 1 illustrates in a schematic way the main constitutive parts of a vehicle in which a braking apparatus according to an embodiment of the present invention can be used.

FIG. 2 illustrates in greater detail the structure of a braking device included in the vehicle of FIG. 1 according to one embodiment of the invention.

FIG. 3 shows a block diagram of the braking apparatus included in the vehicle of FIG. 1 according to an embodiment of the invention;

FIG. 4 shows a cross-section view of the braking device of FIG. 2 according to an embodiment of the invention; and

FIGS. 5a and 5b show a further cross-section view of the braking device of FIG. 2 during two different operation phases according to an embodiment of the invention.

### DETAILED DESCRIPTION

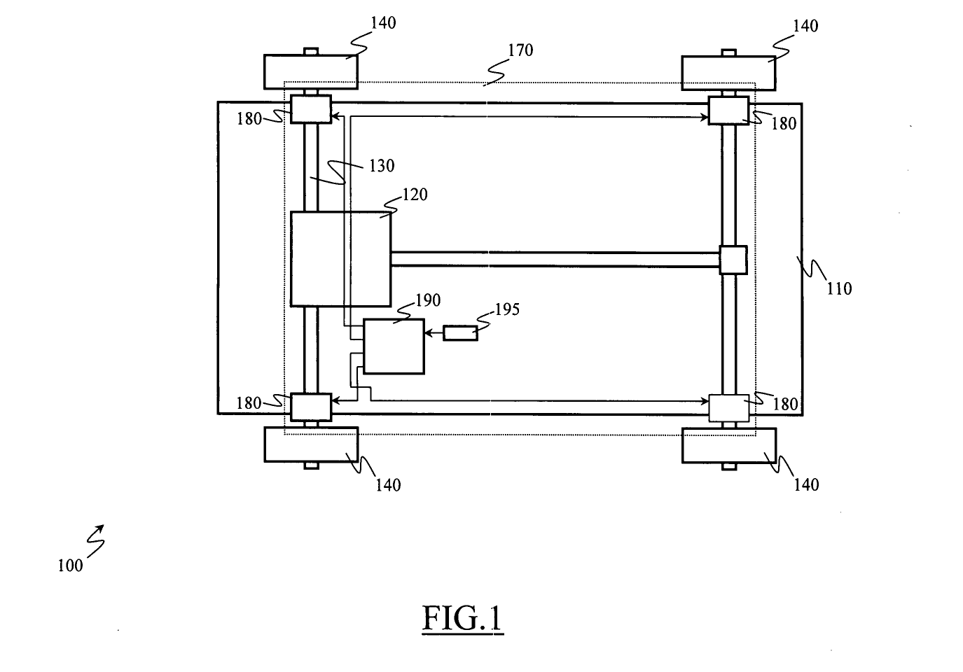

With reference to FIG. 1, some among the main constitutive parts of an embodiment of a vehicle 100—for example a car—are schematically illustrated. In particular, in FIG. 1 there is pointed out the presence of a chassis 110, which constitutes the supporting structure of the vehicle 100; all the other main parts of the vehicle 100 are connected to the chassis 110. In the car models of nowadays, the supporting function of the chassis 110 is substituted by the car body (in this case it is indicated as supporting car body). The vehicle 100 includes an engine 120, adapted to transform the chemical energy of the fuel that feeds it into mechanical work a transmission system 130 transmits the mechanical work produced by the engine 120 to wheels 140—each one generally made up of a metal ring on which a pneumatic is mounted—by means of proper gearing-down systems. The vehicle 100 further includes a drive system (not illustrated in FIG. determining the contemporaneous change of direction of the wheels 140. A braking apparatus 170 is aimed at slowing down the rotation of the wheels 140 or keeping them still.

In particular, the braking apparatus 170 includes a braking device 180 associated with each wheel 140 a control system 190 manages the braking devices 180 according to an action exerted on a brake pedal 195 by a user (not shown in FIG. 1) of the car.

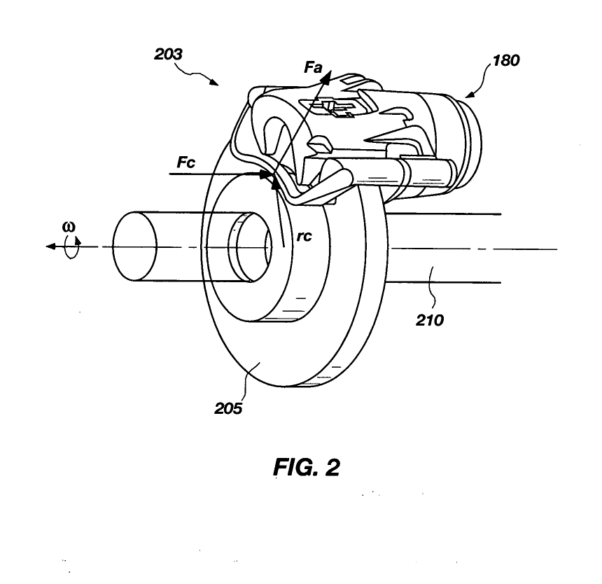

In FIG. 2 the structure of an embodiment of one of the braking devices 180 is illustrated in greater detail. In particular, the braking device 180 is an Electro-Mechanical Brake (EMB) comprising a caliper 203 including an actuator of electromechanical type, which will be described in greater detail below.

A braking disk 205 is mounted on a transmission shaft 210 that is connected to a hub of the wheel (not illustrated). The braking disk 205 then rotates in a way integral to the corresponding wheel.

When the vehicle is moving, the caliper 203 is not in contact with the surfaces of the braking disk 205, which is then free to rotate integrally to the wheel at an angular velocity ω. If the user of the vehicle decides to slow down the vehicle speed, he acts on the brake pedal, for operating the braking apparatus accordingly. The control system of the braking apparatus drives the braking device 180 to cause the closing of the caliper 203 on the braking disk 205. As soon as the caliper 203 is in contact with the surfaces of the braking disk 205, a friction force is generated and originates a torque couple opposing the rotation of the braking disk 205, and, therefore, the rotation of the wheel. In particular, a force Fc exerted by the caliper 203 on each one of the two surfaces of the braking disk 205, having a direction substantially parallel to the rotation axis of the braking disk 205 (only one of which shown in FIG. 1), generates a corresponding friction force Fa, having a direction perpendicular to that of the force Fc, a direction that opposes the rotation of the braking disk 205 and a modulus equal to:

Fa=μ_{c}(ωr_{c}, T)Fc,

where μ_{c}(ωr_{c}, T) is the friction coefficient between the caliper 203 and the braking disk 205. The friction coefficient μ_{c}(ωr_{c}, T) depends on the temperature T of the caliper 203 and of the braking disk 205, and on the difference between the speed of the braking disk 205 in the caliper/disk contact point—that is, ωr_{c}, where r_{c} is the distance of the caliper/disk contact point from the centre of the braking disk—and the speed of the caliper 203—that is, null. Furthermore, the friction coefficient μ_{c}(ωr_{c}, T) depends on numerous other factors that may be difficult to measure with difficulty, and which are, for example, related to the conditions of the materials making up the caliper and the disk.

The friction force Fa originates a braking action (a braking torque) Tb, which opposes the angular speed w, and the modulus of which is equal to

Tb=r_{c} Fa=r_{c} μ_{c}(ωr_{c}, T)Fc.

As it can be observed in the previous equation, the braking action generated by the braking device 180 does not depend only on the force Fc exerted by the caliper 203 on the two surfaces of the braking disk 205, but it depends also on the other parameters mentioned above.

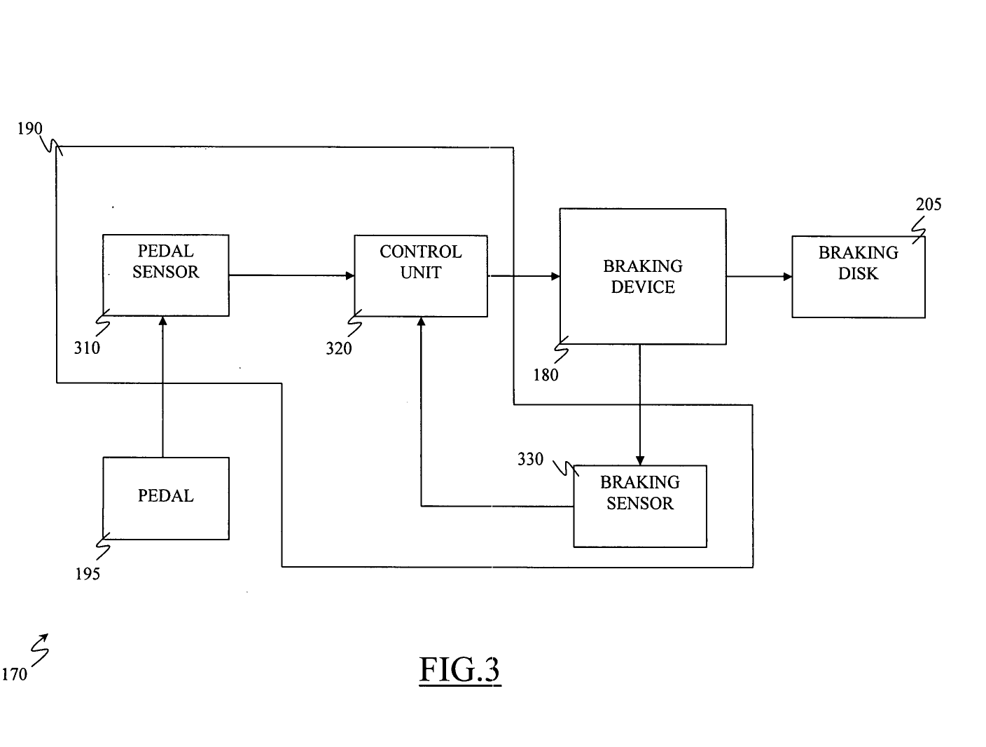

FIG. 3 shows a block diagram of the braking apparatus 170 that describes the logic operation thereof. As previously described, the braking apparatus 170 comprises the brake pedal 195, a braking disk 205 for each wheel, a braking device 180 associated with each braking disk 205, and the control system 190 adapted to control the braking devices 180. For convenience of viewing, in FIG. 3 only one braking device 180 and one braking disk 205 are illustrated.

The control system 190 includes sensors 310 of the brake pedal 195 adapted to sense the stroke and the actuation speed of the brake pedal. An electronic control unit 320 is connected to the sensors 310 of the brake pedal for operating the braking device 180. The electronic control unit 320 may be realized with a device programmable by means of a proper firmware.

In an embodiment of the invention, the control system 190 includes braking sensors 330, adapted to sense the braking action exerted by the braking device 180 on the braking disk 205, which are feedback-connected to the electronic control unit 320.

In operation, the sensors 310 of the brake pedal send data related to the stroke and to the actuation speed of the brake pedal 195 to the electronic control unit 320. In accordance with such data, the electronic control unit 320 generates a command signal for the braking device 180 that indicates the desired value of the braking action. The braking device 180 drives the corresponding caliper as a result of such a command signal, exerting a corresponding braking action on the braking disk 205. The braking sensors 330 sense the braking action actually exerted by the caliper on the braking disk 205, and they feedback such data to the electronic control unit 320. In such a way the electronic control unit 320 exerts a closed-loop control of the braking action, executing a continuous comparison between the desired braking action (target braking action) and that actually exerted by the caliper (actual braking action).

It is therefore possible to improve control of the braking action as compared to prior art teachings. In fact, unlike the known systems—in which only a physical quantity related to the braking action is monitored in an indirect way—the provided control system 190 permits monitoring and directly controlling the actual braking action that is exerted by the caliper 203. In this way the control is significantly more effective, since it is no longer subject to the errors due to possible wrong estimations caused by external factors. An embodiment of this type is possible thanks to the presence of the braking sensors 330, the structure of which will be described and analyzed in greater detail below.

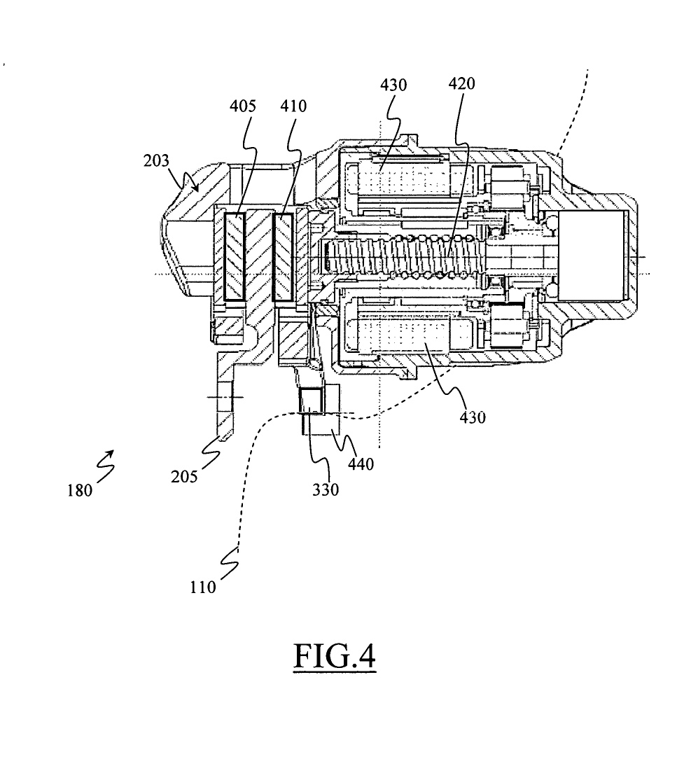

With the aim of explaining the operation of the braking device 180 reference is made now to FIG. 4, which shows such a braking device in a cross section along a cross-section plane crossing the rotation axis of the braking disk 205. The elements corresponding to those illustrated in FIG. 2 are identified by the same reference numerals.

The caliper 203 of the braking device 180 includes a pair of pads of abrasive material, formed by an external pad 405—located in proximity of the side of the braking disk 205 facing toward the outer side of the wheel—and by an internal pad 410—located in proximity of the other side of the braking disk 205. The pads 405 and 410 are coupled with an electromechanical actuator comprising a piston 420 that is able to run along a direction perpendicular to the surface of the braking disk 205 and an electric motor 430—for example, a brushless motor. In accordance with a command signal generated by the electronic control unit of the control system (not shown in FIG. 4), the electric motor 430 generates a driving torque that is transformed in a linear movement of the piston 420 by means of proper mechanical members. The braking device 180 is of floating disk type. In particular, the braking disk 205 is free to move along the direction of its axis, and then it is integral to the corresponding wheel only in rotation. Furthermore, the internal pad 410 is connected directly to the piston 420 or at least acted upon directly by the piston 420, while the external pad 405 as well is free to move along the direction of the braking disk axis. The braking device 180 is fastened to the vehicle chassis 110 by means of constraint supports 440. In an embodiment of the present invention, the braking sensors 330 are connected to the constraint supports 440.

When the braking device 180 is driven by the control system, the electric motor 430 brings the piston 420 in movement. In this way the piston 420 and the internal pad 410 connected thereto are driven in contact with the braking disk 205. Exploiting the freedom of movement of the braking disk 205 in the direction of the rotation axis, the piston 420 and the internal pad 410 push the braking disk 205 against the external pad 405. In this way, a friction force is generated and originates a braking torque that opposes the rotation of the braking disk 205, as already explained previously.

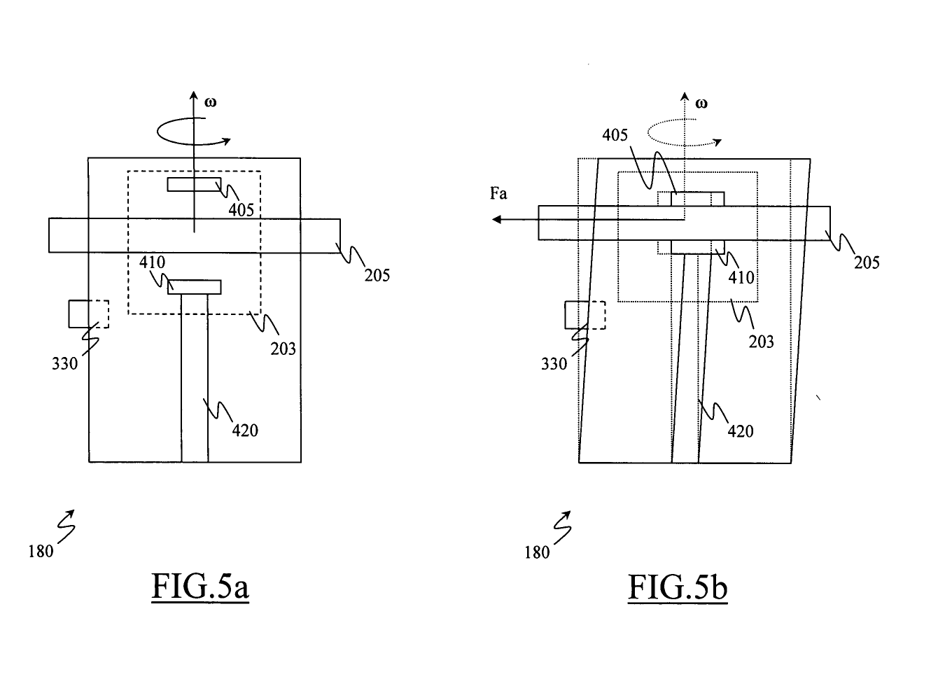

FIGS. 5a and 5b show the braking device 180 in a cross section along a cross-section plane perpendicular to that used for cross-sectioning the braking device 180 of FIG. 4. In order to explain the operation of the braking device 180 according to an embodiment of the invention, FIGS. 5a and 5b have been realized with a degree of detail significantly lower than that used in FIG. 4. The elements corresponding to those illustrated in FIG. 4 are identified with the same reference numerals.

In particular, 5a shows the braking device 180 when the caliper 203 is open, and the pads 405, 410 are not in contact with the surfaces of the braking disk 205. In these conditions, the braking disk 205 is free to rotate at the angular velocity ω.

FIG. 5b instead shows the same braking device 180 when the caliper 203 is closed on the braking disk 205, and the pads 405 and 410 are in close contact with the surfaces of the latter diski. As already described in detail with reference to FIG. 2, the contact of the caliper 203 with the surfaces of the braking disk 205 generates the friction force Fa, the direction of which is such that it opposes the rotation direction of the braking disk 205. A further effect generated by the closing of the caliper 203 is given by the dragging action that the braking disk 205 carries out on the caliper 203. While the braking disk 205 is braked by means of the friction force Fa, the caliper 203 of the braking device 108 tends to be dragged in the rotation direction of the braking disk 205. Such a dragging effect greatly depends on the degree of the friction force Fa. For the same angular velocity ω, the greater the friction force Fa generated by the closing of the caliper 203, the greater the intensity of the dragging effect. Since the caliper 203, and, more generally, the braking device 180, are fastened to the vehicle chassis by means of the constraint supports, the dragging effect of the braking disk 205 originates a warping of the block caliper/braking device 203 and 180. In particular, the caliper 203 and the braking device 180 undergo a torsional warping in agreement with the rotation direction of the braking disk 205, as illustrated in FIG. 5b (for the sake of clarity of illustration, the effect of such a warping has been exaggerated with respect to expected actual warping).

The torsional warping that the caliper 203 and the braking device 180 undergo directly depends on the braking action that the caliper 203 actually exerts on the braking disk 205. In fact, the warping directly depends on the friction force Fa, which is in turn directly related to the braking torque Tb, as previously described. In other words, the actual braking torque Tb is directly proportioned to the warping that the caliper 203 and the braking device 180 undergo. In this way, by means of a measure of the warping a reliable estimation of the actual braking torque Tb is obtained, which inherently considers the dependence on the friction coefficient between the caliper 203 and the braking disk 205.

For this purpose, according to an embodiment of the present invention, the braking sensors 330 connected to the constraint supports are adapted to measure the degree of the torsional warping which both the caliper 203 and the braking device 180 as a whole undergo. For example, such braking sensors 330 may include some piezoresistances, transducer elements able to provide an electric signal proportional to the warping that they undergo. In use, the braking sensors 330 sense such a warping, thus deducing the braking action actually exerted by the braking device 180 on the braking disk 205 and providing such information in feedback to the electronic control unit, as previously described. For example, the actual braking action may depend linearly on the warping, according to a proportionality coefficient depending on the structure of the braking device 180—the coeffient can be determined through experimental measures.

Naturally, in order to satisfy local and specific requirements, a person skilled in the art may apply to the one or more embodiments described above many logical and/or physical modifications and alterations. More specifically, although one or more embodiments of the present invention have been described with a certain degree of particularity with it should be understood that various omissions, substitutions and changes in the form and details as well as other embodiments are possible. Particularly, one or more embodiments may even be practiced without the specific details (such as the numerical examples) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

For example, similar considerations apply if the braking device has a different structure or includes equivalent elements. Analogously, it is possible to sense the desired braking action for driving the braking element in another way. Furthermore, it is possible to use any other system for evaluating the actual braking action.

In any case, it is possible to sense any other type of warping (of the braking device as a whole or of a part thereof), for example, a simple bending; analogously, the actual braking action may be evaluated through different formulas (for example, of logarithmic type), or on the basis of two or more measured values of the warping.

Furthermore, the sensing of the warping of the moving body instead of that of the braking device is not excluded.

Although in the previous description the moving body comprises a rotating wheel, nothing prevents applying the disclosed concepts of to braking devices for bodies that move in other ways (for example, to bodies that do not rotate but only translate).

Although reference has expressly been made in the foregoing to braking devices of the disk type, and in greater detail to floating disk and electronic control braking devices, the disclosed concepts may be applied to other types of brakes—such as, for example, to the ribbon and drum brakes, brakes with not floating disk, hydraulic disk brakes, and so on.

Nothing prevents sensing the warping of any other element of the braking device (in addition or in replacement of the calipers).

For sensing the warping, it is not excluded the possibility of using sensing means different from the piezoresistances—such as, for example, a “strain gauge” devices with a metal or a semiconductor core.

Analogous considerations apply if the braking apparatus has an equivalent structure (for example, with any number of braking devices, down to only one) or if it comprises another unit (for example a control system dedicated to each braking device).

The disclosed concepts lends themselves to be used in any vehicle (for example, a motorcycle).

In any case, nothing prevents one from sensing the warping of elements integral to any other structure that does not follow the rotation of the wheel.

The disclosed concepts lend themselves to be implemented with an equivalent method (using similar steps, removing some, or adding further optional steps—also in different order).

In any case, the managing program of the control unit may take any form suitable to be used by any data processing system, such as software, firmware, or microcode. Moreover, it is possible to provide the program on any computer-usable medium. For example, the medium may be of the electronic, magnetic, optical, electromagnetic, infrared, or semiconductor type. In any case, an embodiment of the present invention lends itself to be implemented with a hardware structure (for example, integrated in a chip of semiconductor material), or with a combination of software and hardware.

1. A control system of a braking device, said braking device including at least one braking element adapted to apply a braking action to a moving body wherein the control system includes:
receiving means for receiving an indication of a target value of the braking action to be applied to the moving body,
measuring means for measuring an indication of an actual value of the braking action applied to the moving body,
driving means for driving the braking element according to a comparison between the target value and the actual value,
Wherein the measuring means includes sensing means for sensing a warping of at least one part of the moving body and/or of the braking device, and logic means) for estimating the actual value according to the warping.

2. The control system of claim 1, wherein the sensing means is adapted to sense the warping of at least one part of the braking device.

3. The control system of claim 2, wherein the moving body includes a rotating wheel and the braking action includes the generation of a braking torque in opposition to the rotation of the wheel.

4. The control system of claim 3, wherein the moving body includes at least one disk rotating integrally to the wheel, the braking device being of the disk type and including:
at least one caliper system supporting at least one piston coupled with a corresponding braking element for pushing the braking element against the disk, said braking torque being generated by means of the friction force between each braking element and the disk.

5. The control system of claim 4, wherein the sensing means is adapted to sense the warping of the at least one caliper system.

6. The control system of claim 5, wherein the sensing means includes at least one piezoresistive element.

7. A method for controlling a braking device, said braking device including at least one braking element adapted to apply a braking action to a moving body, wherein the method composes:
receiving an indication of a target value of the braking action to be applied to the moving body;
measuring an indication of an actual value of the braking action applied to the moving body;
driving the braking element according to a comparison between the target value and the actual value,
sensing a warping of at least one part of the moving body and/or of the braking device, and
estimating the actual value of the braking action according to the warping.

8. A brake assembly, comprising:
a caliper operable to brake a member that is moving in a first direction; and
a sensor operable to generate a signal that is related to a movement of the caliper in a second direction substantially aligned with the first direction.

9. The brake assembly of claim 8 wherein:
the caliper includes a pair of pads and a piston; and
the piston is operable to cause the caliper to brake the member by urging the pads against the member.

10. The brake assembly of claim 8 wherein:
the caliper includes a pair of pads and a piston; and
the piston is operable to cause the caliper to brake the member by urging the pads against the member in a third direction that is substantially perpendicular to the first direction.

11. The brake assembly of claim 8, further comprising:
wherein the caliper includes a pair of pads and a piston; and
a motor operable to cause the caliper to brake the member by urging the piston against one of the pads such that the pads squeeze the member.

12. The brake assembly of claim 8 wherein:
the member comprises a rotating disc; and
the first direction comprises a rotational direction of the disc.

13. The brake assembly of claim 8, further comprising:
a support structure coupled to the caliper; and
wherein the sensor is mounted to the support structure.

14. The brake assembly of claim 8, further comprising:
a support structure coupled to the caliper; and
wherein the sensor is mounted to the support structure and is operable to generate the signal related to a movement of the support structure.

15. The brake assembly of claim 8, further comprising:
a support structure coupled to the caliper; and
wherein the sensor is mounted to the support structure and is operable to generate the signal related to a movement of the support structure in a third direction substantially aligned with the first direction.

16. A brake system, comprising:
a brake-actuating assembly operable to generate an input signal that is related to a requested braking torque;
a brake assembly, comprising,
a caliper operable to brake a member that is moving in a first direction with an actual braking torque in response to a braking signal, and
a first sensor operable to generate a feedback signal that is related to a movement of the caliper in response to the actual braking torque; and
a controller operable to generate the braking signal in response to the input and feedback signals.

17. The braking system of claim 16 wherein the brake-actuating assembly comprises:
a brake member; and
a second sensor operable to generate the input signal related to a position of the brake member.

18. The braking system of claim 16 wherein the brake-actuating assembly comprises:
a brake member; and
a second sensor operable to generate the input signal related to a rate of movement of the brake member.

19. The braking system of claim 16 wherein the controller is operable to generate the braking signal so as to reduce a difference between the input and feedback signals.

20. An apparatus, comprising:
a framework;
a member coupled to the framework and operable to move in a first direction; and
a brake system, including,
a brake-actuating assembly coupled to the framework and operable to generate an input signal that is related to a requested braking torque,
a brake assembly, including,
a caliper coupled to the framework and operable to brake the member with an actual braking torque in response to a braking signal, and
a first sensor operable to generate a feedback signal that is related to a movement of the caliper in response to the actual braking torque, and
a controller operable to generate the braking signal in response to the input and feedback signals.

21. The apparatus of claim 20 wherein the framework comprises an automobile chassis.

22. The apparatus of claim 20 wherein the framework comprises an automobile body.

23. The apparatus of claim 20 wherein the member comprises a rotatable disk.

24. The apparatus of claim 20, further comprising:
a wheel coupled to the framework; and
wherein the member comprises a disk coupled to the wheel such that the caliper is operable to brake the wheel by braking the member.

25. The apparatus of claim 20 wherein the brake-actuating assembly comprises:
a brake pedal coupled to the framework; and
a second sensor operable to generate the input signal related to a position of the brake pedal.

26. The apparatus of claim 20 wherein the brake-actuating assembly comprises:
a brake pedal coupled to the framework; and
a second sensor operable to generate the input signal related to a rate of movement of the brake pedal.

27. The apparatus of claim 20 wherein:
the braking assembly further comprises a support structure coupled to the framework and the caliper; and
wherein the first sensor is mounted to the support structure and is operable to generate the feedback signal related to a movement of the support structure relative to the framework.

28. The apparatus of claim 20 wherein:
the braking assembly further comprises a support structure coupled to the framework and the caliper; and
wherein the first sensor is mounted to the framework and is operable to generate the feedback signal related to a movement of the framework relative to the support structure.

29. A method, comprising:
braking a moving member with a first braking member; and
generating a sense signal that is related to an actual braking torque applied to the member and that is substantially independent of a coefficient of friction between the moving member and the braking member.

30. The method of claim 29 wherein braking the moving member comprises braking the moving member by squeezing the moving member between the first braking member and a second braking member.

31. The method of claim 29 wherein generating the signal comprises generating the signal related to an amount that the moving member moves the first braking member during the braking.

32. The method of claim 29 wherein generating the signal comprises generating the signal related to an amount that the moving member moves a support of the first braking member during the braking.

33. The method of claim 29, further comprising:
generating a braking-request signal;
generating a braking signal in response to the sense and braking-request signals; and
braking the moving member in response to the braking signal.

34. The method of claim 29, further comprising:
generating a braking-request signal in response to a movement of a brake pedal;
generating a braking signal in response to the sense and braking-request signals; and
braking the moving member in response to the braking signal.

35. The method of claim 29, further comprising:
generating a braking-request signal;
generating a braking signal in response to a difference between the sense and braking-request signals; and
braking the moving member in response to the braking signal.

36. The method of claim 29, further comprising:
generating a braking-request signal;
generating a braking signal that drives a value of the sense signal toward a value of the braking-request signal; and
braking the moving member in response to the braking signal.
